(19) United States
(12) Patent Application Publication
(10) Pub. No.: US 2012/0213367 A1
(43) Pub. Date: Aug. 23, 2012

(54) METHOD AND SYSTEM FOR PROVIDING CONTENT TO A CONTENT DISTRIBUTION SYSTEM SUITABLE FOR A MULTIPLE DWELLING UNIT USING AN ENCRYPTION

(75) Inventors: Peter M. Klauss, Torrance, CA (US); Raynold M. Kahn, Los Angeles, CA (US); Thomas H. James, Pacific Palisades, CA (US)

(73) Assignee: The DIRECTV Group, Inc., El Segundo, CA (US)

(21) Appl. No.: 13/461,617

(22) Filed: May 1, 2012

Related U.S. Application Data
(62) Division of application No. 11/862,981, filed on Sep. 27, 2007.

(51) Int. Cl. H04K 1/00

(52) U.S. Cl. 380/270; 380/255

(57) ABSTRACT

A communication system includes a head end. The head end communicates with a system gateway. A plurality of user devices is coupled to the gateway. The gateway receives the plurality of first encrypted signals, decrypts the plurality of first encrypted signals to form unencrypted signals and encrypts the unencrypted signals with a second encryption to form a plurality of second encrypted signals and communicates the second encrypted signals to the plurality of user devices. The signals may also be super-encrypted signals. That is, rather than un-encrypting at the gateway, the first encrypted signals may be again encrypted.

### CROSS-REFERENCE TO RELATED APPLICATIONS

This application is a divisional application of U.S. application Ser. No. 11/862,981, filed Sep. 27, 2007, which application is incorporated by reference herein, and which claims the benefit of co-pending commonly assigned U.S. application Ser. No. 11/862,883, filed Sep. 27, 2007, which application is incorporated by reference herein.

### TECHNICAL FIELD

The present disclosure relates to a content delivery system and, more specifically, to a system that redistributes content to various devices within a building such as a multiple dwelling unit from a gateway on or within the building using encryption.

### BACKGROUND

The statements in this section merely provide background information related to the present disclosure and may not constitute prior art.

Satellite television has become increasingly popular due to the wide variety of content and the quality of content available. A satellite television system typically includes a set top box that is used to receive the satellite signals and decode the satellite signals for use on a television. The set top box typically has a memory associated therewith. The memory may include a digital video recorder or the like as well as the operating code for the set top box.

Satellite television systems typically broadcast content to a number of users simultaneously in a system. Satellite television systems also offer subscription or pay-per-view access to the broadcast content. Access is provided using signals broadcast over the satellite. Once access is provided the user can access the particular content.

It may be desirable to provide satellite television to various users in a building such as a multiple dwelling unit (MDU) such as an apartment building, office building, hotel or hospital. However providing antennas and the associated hardware for each unit on an individual basis is not cost effective and may consume a large portion of the building. This may not be aesthetically pleasing as well.

Providing content to a large number of consumers in a particular building must be done in a secure manner. Authorized users may share a communal subscription, or may be offered individual subscriptions or pay-per-view.

### SUMMARY

The present invention allows content to be distributed throughout a building using a gateway. Authorizations may be obtained through many types of communication means including through a satellite.

In one aspect of the disclosure, a method of operating a communication system includes encrypting a plurality of signals with a first encryption to form a plurality of first encrypted signals, communicating the plurality of first encrypted signals to a system gateway, decrypting the plurality of first encrypted signals at the gateway to form unencrypted signals, encrypting the unencrypted signals at the gateway with a second encryption to form a plurality of second encrypted signals, communicating the second encrypted signals to a plurality of user devices from the gateway.

In another aspect of the disclosure, a method of operating a communication system includes encrypting a plurality of signals with a first encryption to form a plurality of first encrypted signals, communicating the plurality of first encrypted signals to a system gateway, encrypting the first encrypted signals at the gateway with a second encryption to form a plurality of super-encrypted signals, communicating a decryption key to the plurality of user devices and communicating the super-encrypted signals to a plurality of user devices from the gateway.

In yet another aspect of the disclosure, a communication system includes a head end encrypting a plurality of signals with a first encryption to form a plurality of first encrypted signals and a plurality of user devices. The system also includes a system gateway in communication with the head end and the plurality of user devices. The gateway receives the plurality of first encrypted signals, decrypts the plurality of first encrypted signals to form unencrypted signals and encrypts the unencrypted signals with a second encryption to form a plurality of second encrypted signals and communicates the second encrypted signals to the plurality of user devices.

In still a further aspect of this disclosure, a communication system includes a head end encrypting a plurality of signals with a first encryption to form a plurality of first encrypted signals, a plurality of user devices and a system gateway in communication with the head end and the plurality of user devices. The gateway receives the plurality of first encrypted signals, encrypts the first encrypted signals with a second encryption to form a plurality of super-encrypted signals, communicates a decryption key to the plurality of user devices and communicates the super-encrypted signals to the plurality of user devices from the gateway.

To enhance security in the system, some embodiments may include a satellite connection conveying the conditional access packets, encryption information and lists.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagrammatic illustration of a content delivery system according to the disclosure.

FIG. 2 is a flowchart of a first example for a method of operating the present disclosure.

FIG. 3 is a flowchart of a second example for a method of operating the present disclosure.

FIG. 4 is a flowchart of a third example for a method of operating the present disclosure.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

While the following disclosure is made with respect to example DIRECTV® broadcast services and systems, it should be understood that many other delivery systems are readily applicable to disclosed systems and methods. Such systems include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a head end (HE) and integrated receiver/decoders (IRDs) as described below can be reallocated as desired without departing from the intended scope of the present patent.

Further, while the following disclosure is made with respect to the delivery of content (e.g., television (TV), movies, music videos, etc.), it should be understood that the systems and methods disclosed herein could also be used for delivery of any media content type, for example, audio, music, data files, web pages, games, etc. Additionally, throughout this disclosure reference is made to data, information, programs, movies, assets, video data, etc., however, it will be readily apparent to persons of ordinary skill in the art that these terms are substantially equivalent in reference to the example systems and/or methods disclosed herein. As used herein, the term title will be used to refer to, for example, a movie itself and not the name of the movie.

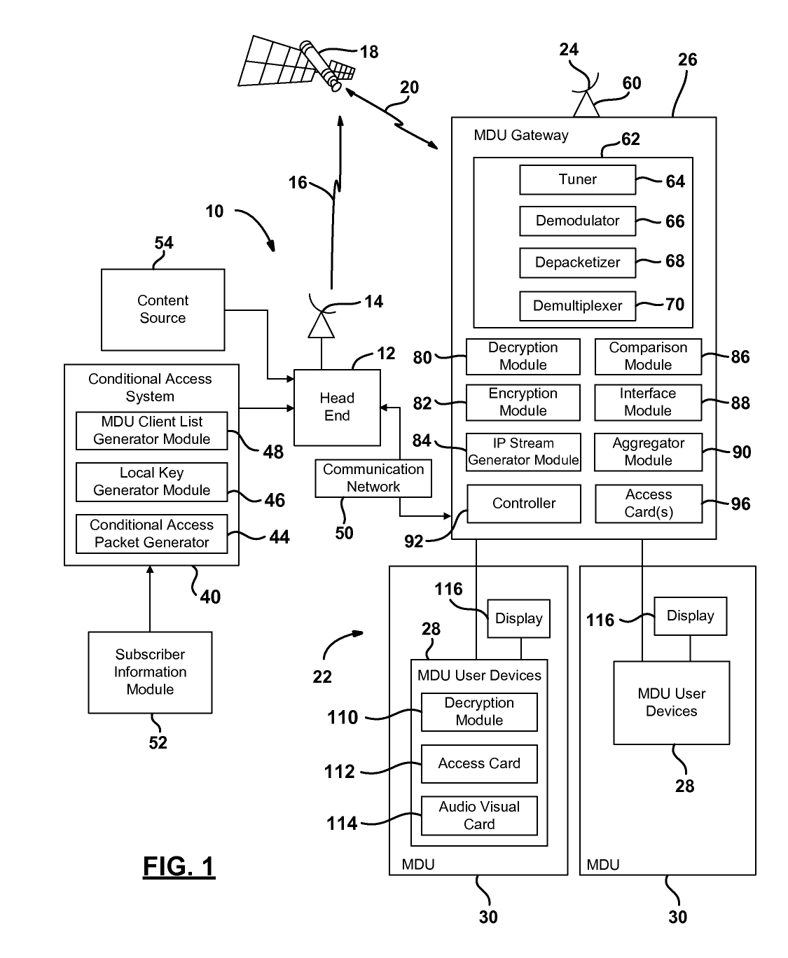

As illustrated in FIG. 1, a communication system 10 includes a head end 12 that is coupled to an uplink antenna 14. The head end 12 may be used for many things, including multiplexing, modulating and uplinking signals 16 to satellite 18. It should be noted that satellite 18 may comprise a number of satellites operating in a system. The satellite 18 is used to generate downlink signals 20 to a multiple dwelling unit (MDU) delivery system 22, and, more specifically, to an antenna 24 of the multiple dwelling unit (MDU) delivery system 22. The multiple dwelling unit (MDU) delivery system 22 may include a gateway 26 that is used to receive signals from the satellite and distribute the signals to various client or user devices 28 that also constitute part of the MDU delivery system 22. Multiple dwelling unit (MDU) delivery system 22 may also be used to process the received satellite signals. The user devices 28 may be referred to as a set top box, a satellite set top box, or an integrated receiver decoder. The wireless communications between the head end 12 and the multiple dwelling unit (MDU) delivery system 22 may take place at any suitable frequency such as Ka band and/or Ku band frequencies. Information signals may also be communicated from the multiple dwelling unit (MDU) delivery system 22 to the head end 12 through the satellite 18. The delivery system 22 may use Internet protocol to delivery the content therein. Each user device and the gateway may have an IP address assigned thereto and use the respective IP addresses to communicate.

The multiple dwelling unit delivery system 22 communicates signals within a multiple dwelling unit 30. The multiple dwelling unit 30 may comprise various types of buildings in which multiple user devices are coupled to a gateway. Examples of such buildings include, but are not limited to, an apartment building, condominium, office building, hotel or hospital. The service gateway 26 is associated with the particular MDU 30. One or more gateways 26 may be provided. The gateway or at least the antenna 24 may be mounted to an outer roof structure or wall. The various modules of the gateway 26 may be disposed within the MDU 30. The gateway 26 may be wired or wirelessly connected to the user devices 28.

Various types of content and security information signals including but not limited to security information, encryption-decryption information, digital rights management information, purchase information packets (PIPs), conditional access packets (CAPs), channel or content access lists or rights may be communicated through the communication system 10. It should also be noted that various content may be encrypted based upon a control word (CW) known to the head end 12 and known to the various user devices and/or to the MDU gateway 26 and/or multiple dwelling unit (MDU) delivery system 22 authorized to view and/or play back the content. The control word packets (CWPs) may include, among other things, a time stamp, authorization requirements and an input value for generating the control word. Control word packets may from time to time be transmitted to the satellite to the MDU gateway 26.

The multiple dwelling unit (MDU) delivery system 22 may also communicate to the head end 12 through a communication network 50. The communication network 50 may include various types of communication, including but not limited to a telephone-type communication link, an Internet-type communication link, a fiber optic communication link, a wired terrestrial communication link, a terrestrial wireless or cellular link. The communications through the communication network 50 may include content signals into the MDU delivery system 22. The communication network 50 may replace the satellite 18. The MDU delivery system 22 may also transmit call back information such as program and pay-per-view requests and reportback, interactive television signals and gaming signals.

A conditional access system 40 may be coupled to or be part of the head end 12. The conditional access system 40 includes a permission packet generator such as a conditional access packet generator 44 and a local key generator module 46. A MDU client list generator module 48 may also be included within the conditional access system 40. The MDU client list generator module 48 may generate a user list in response to information from a subscriber information module 52. The signals from the conditional access system 40 are communicated to the head end 12 where the signals are broadcast to the (MDU) delivery system 22.

The subscriber information module 52 receives or collects information regarding the permissions of the various users. The information may take the form of a user list that includes channel or content permission authorizations for each of the various users. The users may be identified in various manners including using an IP address. The IP address may be specific to the MDU delivery system. That is, both the MDU delivery system 22 and/or the MDU gateway 26 and the user device 28 may be identified in the user list. Security information such as encryption or decryption information may also be in the user list. The security information may include but is not limited to local key information.

A content source 54 may include a content delivery network, a content repository having contents received from a content provider or providers. The content may be various types of content including video, audio, games, data, or the like. A number of different content providers may be used to provide various types of content to the content source 54. The content source 54 may be coupled to the head end 12 to provide conventional satellite television service. The contents of the content source 54 may be provided in various ways including through a fiber optic network, satellite, telephone line, tapes, or DVDs.

Referring back to the multiple dwelling unit (MDU) delivery system 22, the receiving antenna 24 receives signals that may include modulated multiplexed bit stream signals from the satellite 18 or communication network 50. The receive antenna signals are coupled from a reflector and a feed to a low noise block (LNB) 60 which amplifies and frequency-down converts the receive signals. The output of the LNB 60 is provided to a receiver 62 that receives the signals and may include a tuner 64, demodulator 66, a depacketizer 68, and a demultiplexer 70.

The gateway 26 may also include a decryption module 80 that is used for decrypting the incoming signals from the communication network 50 or the satellite 18. As will be further described below, the decryption module 80 may provide conventional satellite broadcast decryption. The decryption module 80 is an optional module for the system. The decryption module 80 may not be required at the gateway 26 if the individual user devices 28 perform the satellite broadcast decryption.

An access card or access cards 96 may also be included in the gateway 26. The access cards 96 may be used to generate control words for decrypting the incoming signals. The control words provide access to authorized content and channels. The access cards 96 may also be referred to as smart cards. A number of access cards 96 may be used to generate control words and thereby provide access to various channels, groups of channels or various programs or content. The control words may also be encrypted by the access cards 96 to form encrypted control words. The control words or the encrypted control words may be provided to the decryption module 80 at the gateway or may be transmitted to the user devices 28 to perform decryption. Different combinations of decryption and encryption will be described below.

An encryption module 82 may also be provided within the gateway 26. The encryption module 82 may be used to re-encrypt or super-encrypt the signals received from the communication network 50 or the satellite 18. Super-encryption is provided when encrypted signals are again encrypted with a local key. The encryption module 82, whether re-encrypted or super-encrypted, may use a local key. The encryption module 82 is an optional module for the system. The encryption module 82 may not be required if re-encryption or super-encryption is not provided at the gateway 26.

An IP stream generator module 84 may be used to generate an IP stream of the various channels or content received from the communication network 50 or satellite 18. The IP stream may broadcast signals to all user devices or target specific devices using the associated IP address.

A comparison module 86 may be used to compare a received list that is generated at the client list generator module 48 of the conditional access system 40 with a request from a user device 28. As will be mentioned below, the comparison module may provide access to a channel or content if the user device 28 is subscribed to the particular channel or content based upon the list.

An interface module 88 may be used to interface to the communication network 50. The interface module may transmit or receive information or signals from the communication network 50. The interface module 88 may format or reformat the material so it is suitable for communication using the particular medium.

An aggregator module 90 may also be included in the gateway 26. The aggregator module 90 may receive signals from the various user devices 28, collect them and form one consolidated communication signal through the communication network 50 or the satellite 18 to communicate the signals to the head end 12. The gateway 26 may also include a controller 92 for controlling various operations within the gateway 26. The controller 92 may be microprocessor-based. The various modules within the gateway 26 may also be incorporated in software within a controller 92.

The user devices 28 are in communication with the gateway 26. The gateway 26 and the user devices 28 may form a network such as a wired network or a wireless network. The gateway 26 communicates various content or channels or security information signals to each user device through the network. Each user device 28 may include a decryption module 110, an access card 112, and an audio-visual card 114. The audio-visual card 114 may include various functions including a tuner function, a demodulator function, a packetizer function, and a multiplexer function in much the same way as the receiver card 62 illustrated in the gateway 26. The user device 28 may also be associated with or include a display 116. The display 116 may include a television or other monitor-type device.

The decryption module 110 may be used to decrypt the signals from the gateway 26. Also, as mentioned above, the receive signals may not be encrypted at the gateway 26 and, thus, the decryption module may be used to decrypt the signals as they were transmitted from the satellite. Also, the decryption module 110 may provide double decryption to decrypt the super-encrypted signals. That is, the decryption module 110 may use a local key to, first, decrypt the signals to the condition the signals were received by the satellite. The signals may then use another decryption key for the communication system to decrypt the signals as they were transmitted through the satellite system.

The access card 112 may be used to generate control words to perform the decryption. Typical satellite television systems include an access card or conditional access card.

As mentioned above, a network may be formed between the user devices 28 and the gateway 26. That is, the gateway 26 may include an Internet protocol address. Each user device 28 may also include an Internet protocol address. The Internet protocol address may be compared in the comparison module as an identifier for comparison with the channel authorizations provided in the list. This will be further described below.

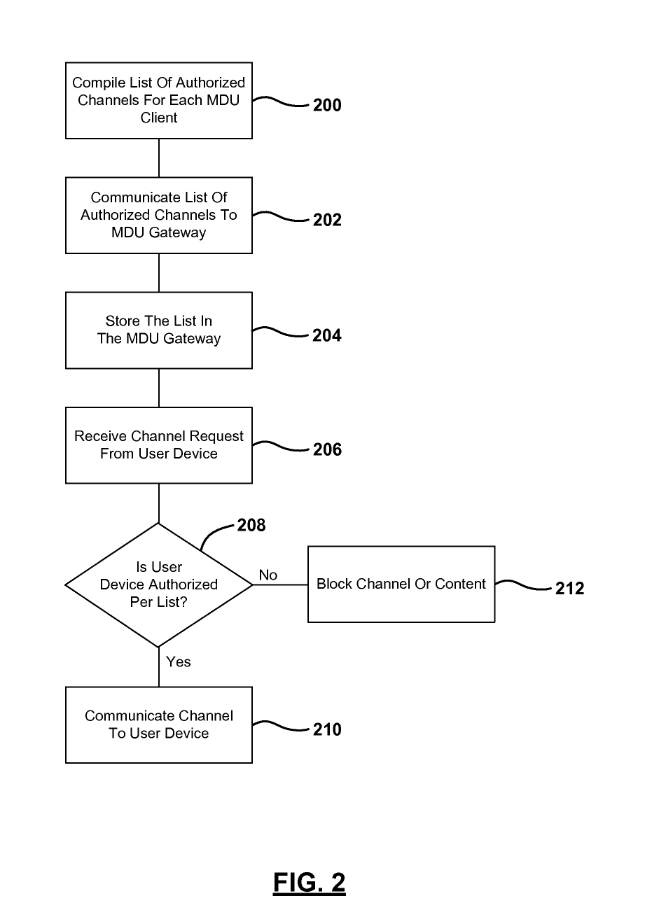

Referring now to FIG. 2, a first method for operating the system is illustrated. In step 200, a list of authorized channels for each multi-dwelling unit may be compiled. The list may be compiled in a business center associated with the head end 12. The list may also be compiled in a subscriber information module 52. In step 202, a list of authorized channels is communicated to the MDU gateway 26. The list of authorized channels may include a list of channels authorized for each of the user devices associated with the multiple dwelling unit delivery system 22. The list may identify the authorized user devices by way of a user identifier or device identifier or an Internet protocol address. The list may be communicated through a satellite 18 or through the communication network 50. In step 204, the list is stored in the gateway. In step 206, a channel request is received from a user device within the multiple dwelling unit delivery system 22.

In step 208, the list is compared to the user device. If the user device is authorized to receive the channel or content in step 208, step 210 communicates the channel or content to the device 28. In step 208, if the user device 28 is not authorized to receive the channel or content, step 212 blocks the channel or content.

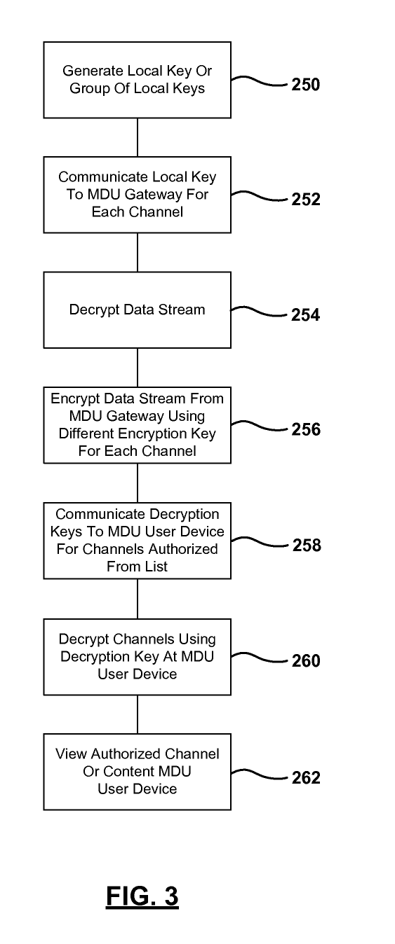

Referring now to FIG. 3, in an alternative embodiment to that illustrated in FIG. 2 or an additional embodiment to be used in conjunction with FIG. 2, step 250 generates a local key or group of local keys. That is, a local key may be generated at the gateway 26 or head end 12 for each channel. It should also be noted that a group of channels may include the same local key. For example, a subscription service may include a subscription to a number of channels and, thus, only one local key may be required for all of the channels in that group.

In step 252, the local keys are communicated to the MDU gateway 26 for each channel. This step is performed if the head end generates the local keys. This is an optional step since local keys may be generated at the gateway 26. In step 254, the received data stream, such as the channel, may be decrypted at the gateway 26. This is an optional step since the data stream may be decrypted at the user device 28.

In step 256, the data stream of content or a channel from the gateway 26 may be encrypted using a different encryption key for each channel or group of channels. This re-encryption or super-encryption may be performed using the local keys generated in step 250. In step 258, the decryption keys may be communicated to the user devices for channels authorized from the list. In step 260, the channels are decrypted using the decryption key at the MDU user device. It should be noted that, in the case of super-encryption, a local key may be used to first decrypt these signals then a broadcast decryption key may be used to further decrypt the channel or content signals. In step 262, the authorized channel or content may be viewed by the user device 28. As is mentioned above, the steps of FIG. 3 may be used together with the steps of FIG. 2. That is, encryption and decryption may also be performed when the channel is communicated to the user device in step 210 of FIG. 2. Also, the encryption information may be contained in the list or may be broadcast in a CAP or other communication packet from time to time. The encryption packet may itself be encrypted.

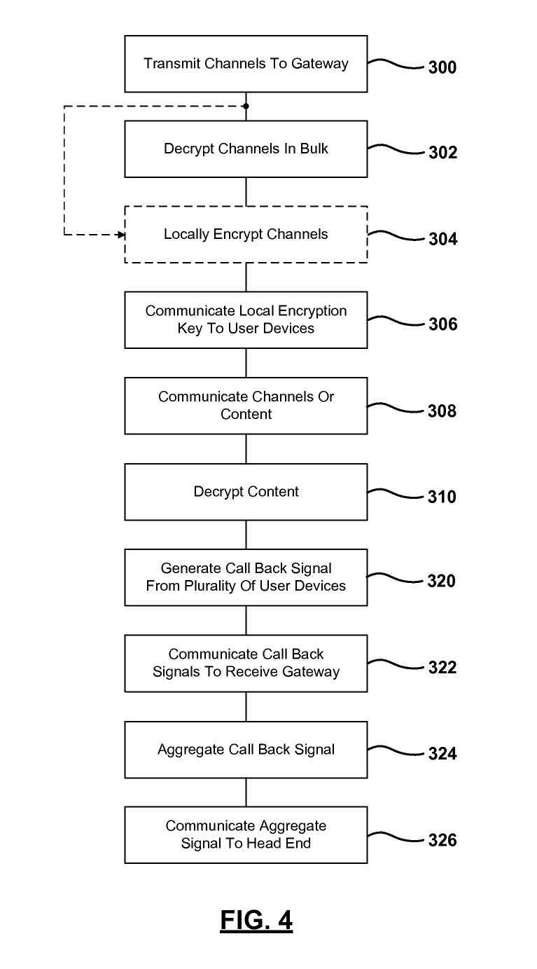

Referring now to FIG. 4, another method for operating the communication system 10 is illustrated. In step 300, the channels are transmitted to a gateway 26. In step 302, the received channels may be decrypted in bulk at the gateway 26. Step 302 may also be skipped if the received channels are decrypted at the user device 28. In step 304, the channels or content may be locally encrypted. The local re-encryption or super-encryption may take place in the gateway 26 using local keys as described above. In step 306, the local encryption key is communicated to the user devices 28. In step 308, the various channels or content may be communicated to the user devices. In step 310, the content is decrypted or super-decrypted as mentioned above.

In step 320, call back signals may be generated from the plurality of user devices. Such call back may comprise program and pay-per-view requests and reportback, interactive television signals and gaming signals. In step 322, the call back signals are communicated to the service gateway. In step 324, the call back signals may be aggregated at the gateway. In step 326, the aggregate signal is communicated to the head end. The aggregate signal may be communicated over the satellite or communicated over the communication network.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method of operating a communication system comprising:
encrypting a plurality of signals with a first encryption to form a plurality of first encrypted signals;
communicating the plurality of first encrypted signals to a system gateway;
encrypting the first encrypted signals at the gateway with a second encryption to form a plurality of super-encrypted signals;
communicating a decryption key to the plurality of user devices; and
communicating the super-encrypted signals to a plurality of user devices from the gateway.

2. A method as recited in claim 1 wherein the plurality of signals comprises channel signals.

3. A method as recited in claim 1 wherein the plurality of signals comprises content signals.

4. A method as recited in claim 1 wherein the second encryption comprises a local key.

5. A method as recited in claim 4 further comprising communicating the local key to the plurality of user devices.

6. A method as recited in claim 4 further comprising communicating the local key to the plurality of user devices through a terrestrial network.

7. A method as recited in claim 4 further comprising communicating the local key to the plurality of user devices through a satellite.

8. A method as recited in claim 1 wherein communicating the plurality of first encrypted signals comprises communicating the plurality of first encrypted signals through a satellite.

9. A method as recited in claim 1 further comprising generating a plurality of return signals from a respective plurality of user devices and communicating the plurality of return signals to the system gateway.

10. A method as recited in claim 9 further comprising aggregating the plurality of return signals at the gateway to form an aggregate signal and communicating the aggregate signal to a head end.

11. A method as recited in claim 10 wherein communicating the aggregate signal to the head end comprises communicating the aggregate signal through a satellite.

12. A method as recited in claim 10 wherein communicating the aggregate signal to the head end comprises communicating the aggregate signal through a wireless communication system.

13. A method as recited in claim 10 wherein communicating the aggregate signal to the head end comprises communicating the aggregate signal through a wired communication system.

14. A communication system comprising:
a head end encrypting a plurality of signals with a first encryption to form a plurality of first encrypted signals;
a plurality of user devices; and
a system gateway in communication with the head end and the plurality of user devices, receiving the plurality of first encrypted signals, encrypting the first encrypted signals with a second encryption to form a plurality of super-encrypted signals, communicating a decryption key to the plurality of user devices and communicating the super-encrypted signals to the plurality of user devices from the gateway.

15. A system as recited in claim 14 further comprising a satellite in communication with the gateway and the head end communicating the user list.

16. A system as recited in claim 14 further comprising a terrestrial communication network in communication with the gateway and the head end communicating the user list.

17. A system as recited in claim 14 wherein the plurality of user devices comprise multiple dwelling unit devices and the gateway comprises a multiple dwelling unit gateway.

18. A system as recited in claim 14 wherein the system gateway and the plurality of user devices are disposed within a multiple dwelling unit.

19. A system as recited in claim 14 wherein the plurality of first encrypted signals comprises content signals.

20. A system as recited in claim 14 wherein the plurality of first encrypted signals comprises channel signals.

21. A system as recited in claim 14 wherein the super-encrypted signals are decrypted at the plurality of user devices.
